(19) United States
(12) Patent Application Publication
(10) Pub. No.: US 2017/0010354 A1
(43) Pub. Date: Jan. 12, 2017

(54) WEATHER RADAR APPARATUS, AND CONTROL APPARATUS AND CONTROL METHOD THEREOF

(71) Applicant: KABUSHIKI KAISHA TOSHIBA, Tokyo (JP)

(72) Inventors: Tomomi AOKI, Yokohama (JP); Kazuaki Kawabata, Yokohama (JP); Yasuhiko Tanabe, Kawasaki (JP)

(21) Appl. No.: 15/205,442

(22) Filed: Jul. 8, 2016

(30) Foreign Application Priority Data
Jul. 10, 2015 (JP) 2015-138801

(51) Int. Cl. G01S 13/95

(52) U.S. Cl. CPC G01S 13/95; G01S 2013/0254

(57) ABSTRACT

According to an embodiment, a weather radar apparatus includes the following elements. The feature quantity calculator calculates, based on the weather information for the targets in an observation range, a feature quantity of each of the targets. The allocator performs transmit allocation in pulse unit or pulse pair unit to the targets based on the feature quantity. The allocation halt instruction unit instructs the allocator to halt transmit allocation to a target satisfying a certain condition. The beam controller generates a control signal to control a beam direction and transmit timing based on a result of the transmit allocation. The transmit signal generator generates a transmit signal based on the control signal. The array antenna transmits the transmit signal.

### CROSS-REFERENCE TO RELATED APPLICATIONS

This application is based upon and claims the benefit of priority from Japanese Patent Application No. 2015-138801, filed Jul. 10, 2015, the entire contents of which are incorporated herein by reference.

### FIELD

Embodiments described herein relate generally to a weather radar apparatus.

### BACKGROUND

It has been a demand in weather observation to increase observation speed in order to detect rapid-developing and quick-moving local weather phenomena. Also, where an observation range includes a plurality of targets such as storms and non-severe rains, pulses should be appropriately allocated to these targets in order to observe all the targets with high accuracy.

### BRIEF DESCRIPTION OF THE DRAWINGS

FIG. 1 is a block diagram showing a weather radar apparatus according to a first embodiment.

FIG. 2 is a flowchart showing an example of a transmit allocation method according to the first embodiment.

FIG. 3A is a table showing an example of weather conditions of three targets.

FIG. 3B shows a result of continuous pulse allocation under the conditions in FIG. 3A.

FIG. 3C shows a result of allocation according to the first embodiment under the conditions in FIG. 3A.

FIG. 4 is a block diagram showing a weather radar apparatus according to a second embodiment.

FIG. 5 is a flowchart showing an example of a transmit allocation method according to the second embodiment.

FIG. 6A is a table showing an example of weather conditions of three targets.

FIG. 6B shows allocations of the three targets when continuous pulse allocation is performed in accordance with the update times shown in FIG. 6A without regard to the other targets.

FIG. 6C shows a result of continuous pulse allocation under the conditions in FIG. 6A.

FIG. 6D shows a result of allocation according to the second embodiment under the conditions in FIG. 6A.

FIG. 7A is a table showing an example of weather conditions of three targets.

FIG. 7B shows a result of allocation according to the second embodiment under the conditions in FIG. 7A.

FIG. 8 is a block diagram showing a weather radar apparatus according to a third embodiment.

FIG. 9 is a flowchart showing an example of a transmit allocation method according to the third embodiment.

### DETAILED DESCRIPTION

According to an embodiment, a weather radar apparatus includes a weather information acquisition unit, a feature quantity calculator, an allocator, an allocation halt instruction unit, a transmit signal generator, and an array antenna. The weather information acquisition unit acquires weather information for targets in an observation range.

The feature quantity calculator calculates a feature quantity of each of the targets based on the weather information. The allocator performs transmit allocation in pulse unit or pulse pair unit to the targets based on the feature quantity. The allocation halt instruction unit instructs the allocator to halt transmit allocation to a target satisfying a certain condition. The beam controller generates a control signal to control a beam direction and transmit timing based on a result of the transmit allocation. The transmit signal generator generates a transmit signal based on the control signal. The array antenna transmits the transmit signal.

Hereinafter, embodiments will be described with reference to the drawings.

### First Embodiment

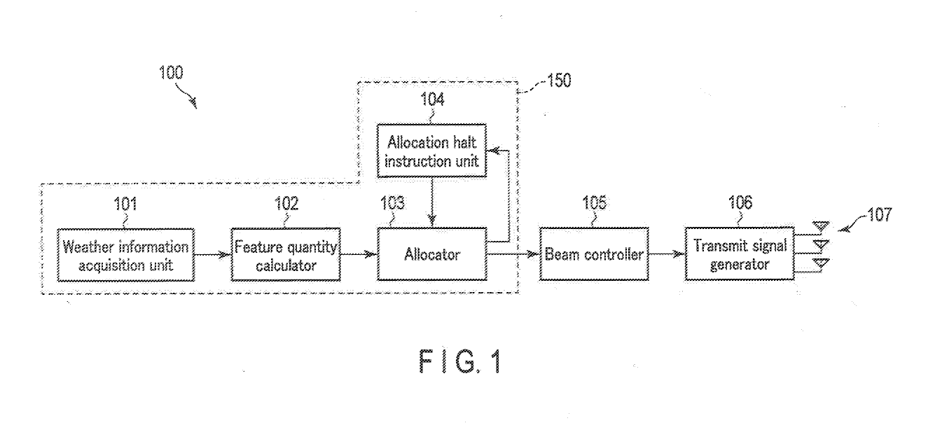

FIG. 1 schematically shows a weather radar apparatus 100 according to the first embodiment. The weather radar apparatus 100 observes weather phenomena by transmitting radio waves (pulse beams) from an array antenna 107 and receiving their reflected waves. Radio waves of the array antenna 107 may be electronically scanned.

The weather radar apparatus 100 has two observation modes, namely, an overall observation mode and a target observation mode, and periodically switches these observation modes. The overall observation mode is a mode to observe an observation range as a whole in order to grasp the weather situations in the entire observation range. Through observation in the overall observation mode, information about targets in an observation range is acquired.

The target observation mode is a mode to intensively observe the range of a target's presence in order to acquire detailed information about the target. The number of pulses required to obtain a desired observation accuracy depends on the weather situation of a target. Accordingly, if there are a plurality of targets in an observation range, pulses need to be adaptively allocated to each target so that a desired observation accuracy may be obtained for all the targets. Transmit allocation may be performed in pulse unit or pulse pair unit. A pulse pair means two consecutive pulses with a pulse repetition interval (PRI) therebetween. Use of a pulse pair allows measurement of the wind velocity of a target. In this embodiment, descriptions will be made to the cases where transmit allocation is performed in pulse pair unit. The descriptions would basically hold true for the transmit allocation in pulse unit if pulse pair is read as pulse.

The weather radar apparatus 100 includes a weather information acquisition unit 101, a feature quantity calculator 102, an allocator 103, an allocation halt instruction unit 104, a beam controller 105, a transmit signal generator 106, and the array antenna 107, as shown in FIG. 1. An allocation controller 150 including the weather information acquisition unit 101, the feature quantity calculator 102, the allocator 103 and the allocation halt instruction unit 104 is a portion involved with the transmit allocation. While the allocation controller 150 is shown as a part of the weather radar apparatus 100 in FIG. 1, it may be realized as an independent device and applied to weather radar apparatuses.

The weather information acquisition unit 101 acquires weather information for targets in an observation range. This weather information is generated based on the result of observation in the overall observation mode. The weather information includes, for example, the number of targets, and the location, velocity width and received power of each target, etc. Here, presence of a plurality of targets in the observation range will be supposed.

The feature quantity calculator 102 calculates a feature quantity of each target based on the weather information acquired by the weather information acquisition unit 101. The feature quantity is, for example, a revisit time. The revisit time corresponds to a time such that adjacent pulse pairs have no correlation therebetween. In other words, the revisit time corresponds to a time such that a sample (specifically, a received signal) based on a pulse pair and a sample based on a succeeding pulse pair are uncorrelated. The revisit time is, for example, the time where a correlation coefficient ρ in below Expression (1) is equal to or less than a prescribed value.

$$p ( t ) = exp ( - \frac{8 {( π {σ}_{V} t )}^{2}}{{λ}^{2}} ) \qquad ( 1 )$$

In Expression (1), σᵥ is a velocity width, and Δ is a wavelength of the beam used for observation. The prescribed value is set at, for example, 0.01. Alternatively, the feature quantity may be a value based on the revisit time, instead of the revisit time itself.

Further, the feature quantity may be based on other indices useful for transmit allocation. The descriptions herein will suppose that the feature quantity is the revisit time.

The allocator 103 performs transmit allocation to targets, in pulse pair unit, based on the feature quantity calculated by the feature quantity calculator 102. For example, the allocator 103 may preferentially allocate pulse pairs to a target with a shorter revisit time.

The allocation halt instruction unit 104 instructs the allocator 103 to halt pulse allocation to a target that satisfies a predetermined condition. In one example, the allocation halt instruction unit 104 instructs the allocator 103 to halt pulse allocation to a target having an allocation number, which indicates the number of pulses allocated to the target, equal to or greater than a prescribed value. The prescribed value is, for example, the maximum pulse number set for each target by the feature quantity calculator 102. The prescribed value may be determined based on weather situations. In this case, the prescribed value typically varies target-by-target. The prescribed value may be the number of pulses required to obtain an observation accuracy determined in advance for observation with continuous pulses. The observation accuracy is, for example, a standard deviation of a weather parameter obtained from the number of pulses and a signal-to-noise (SN) ratio, velocity width, etc. The weather parameter is, for example, a radar reflection factor, a difference in radar reflection factor between polarized waves, Doppler velocity, a rate of change in phase difference between polarized waves, etc. The weather parameter used for determining the prescribed value may be common to all targets or different for each target. Also, a single weather parameter or multiple weather parameters may be used for determining the prescribed value. Alternatively, the allocation halt instruction unit 104 may retain a look-up table defining the prescribed value to have multiple patterns according to weather situations. The prescribed value may also be voluntarily set by operators.

In another example, the allocation halt instruction unit 104 calculates an observation accuracy of a target each time the allocator 103 allocates a pulse pair to the target, and compares the calculated observation accuracy to a prescribed value provided in advance. In this instance, the allocation halt instruction unit 104 does not compare the allocation number to the prescribed value, but compares the observation accuracy resulted from the allocation to the prescribed value. The allocation halt instruction unit 104 instructs the allocator 103 to halt pulse allocation to a target of which observation accuracy resulted from the allocation is equal to or greater than the prescribed value. The prescribed value for the observation accuracy may be voluntarily set by operators or may be a typical value used as an accuracy specification in weather predictions. The prescribed value may vary target-by-target. The weather parameter used for determining the prescribed value may be common to all targets or different for each target. Also, a single weather parameter or multiple weather parameters may be used for determining the prescribed value.

Having the allocation halt instruction unit 104 allows allocation of pulses such that the same observation accuracy may be obtained for each target, or different observation accuracies may be obtained for the respective targets according to the degree of importance.

The beam controller 105 generates a control signal to control the beam direction and transmit timing based on the result of transmit allocation by the allocator 103. The beam controller 105 performs beam control based on the result of transmit allocation by the allocator 103 such that an appropriate target is irradiated with the beam at an appropriate timing.

The transmit signal generator 106 generates a transmit signal based on the control signal generated by the beam controller 105. The array antenna 107 transmits the transmit signal generated by the transmit signal generator 106.

Next, the operation example of the weather radar apparatus 100 will be described.

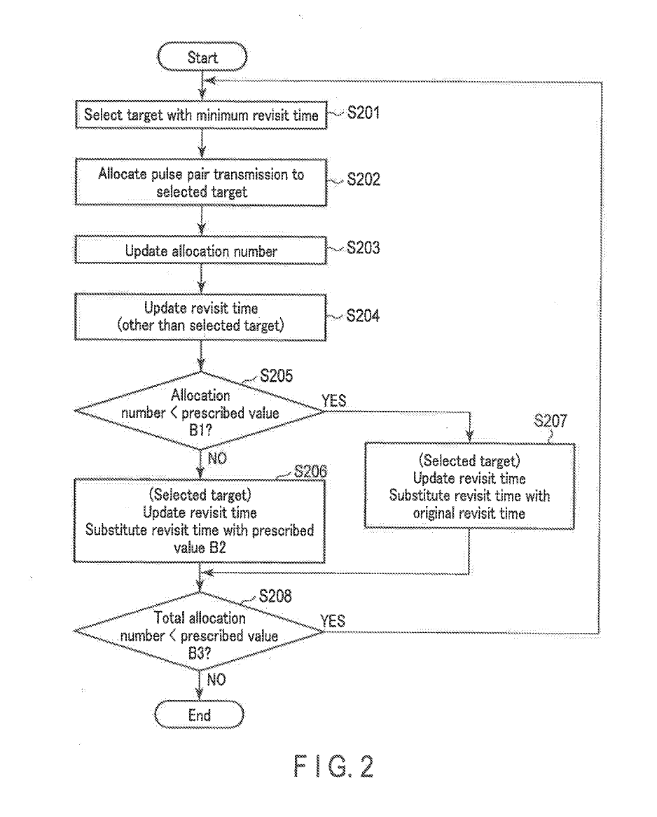

FIG. 2 shows an example of the transmit allocation method according to the embodiment. The weather radar apparatus 100 first operates in the overall observation mode and generates weather information for the targets in an observation range. The feature quantity calculator 102 calculates the revisit times of the respective target based on the generated weather information. The allocator 103 retains the revisit time of each target calculated by the feature quantity calculator 102 as an original revisit time (initial value).

At step S201 in FIG. 2, the allocator 103 selects a target with the minimum revisit time. Note that when the feature quantity used is other than the revisit time itself, the allocator 103 may select a target with the maximum feature quantity or a target with the feature quantity closest to an average.

At step S202, the allocator 103 allocates a pulse pair to the selected target. At step S203, the allocator 103 updates the allocation number for the selected target. Specifically, the allocator 103 adds 2Tₛ to the allocation number for the selected target. Tₛ indicates a PRI. Here, the number of pulses is expressed in time dimension. For allocation in pulse unit, the allocator 103 adds Tₛ to the allocation number for the selected target. Note that the initial value of the allocation number for each target is zero.

At step S204, the allocator 103 updates the revisit time of each target other than the selected target. Specifically, the allocator 103 subtracts 2 Tₛ from the revisit time of each target other than the selected target. Note that the value subtracted from the revisit time need not be 2 Tₛ. For example, the value subtracted from the revisit time may be an average revisit time Tₐᵥₑ obtained by dividing the total sum of original revisit times of the targets by the number of the targets. In this instance, if there is a target of which revisit time after subtraction of the average revisit time Tₐᵥₑ gives a negative value, the allocator 103 substitutes the revisit time of this target with the original revisit time. Thereby, the frequency of selecting a target with a longer revisit time may be increased when the difference in length of the revisit times is large, and the interval between the pulse pairs for each target may be provided appropriately. When pulse pairs are transmitted with intervals, the same accuracy as in the case of continuous pulse transmissions may be achieved using a smaller number of pulses. Therefore, this embodiment may decrease the number of transmitted pulses and accordingly realize fast observation.

At step S205, the allocation halt instruction unit 104 compares the allocation number for the selected target to a prescribed value B1 of this target. If the allocation number is equal to or greater than the prescribed value B1, the operation proceeds to step S206. If the allocation number is less than the prescribed value B1, the operation proceeds to step S207.

At step S206, the allocator 103 substitutes the revisit time of the selected target with a prescribed value B2. The prescribed value B2 may be set at a sufficiently large value so that no more pulse pairs will be allocated to a target having the allocation number equal to or greater than the prescribed value B1. For example, the prescribed value B2 is a sum of the largest revisit time among the original revisit times of the targets and a total observation time in the target observation mode. That is, when the largest revisit time among the original revisit times of the targets is expressed as Tₘₐₓ and the total observation time in the target observation mode is expressed as Tₜ, the relationship given is B2=Tₘₐₓ+Tₜ. If at step S204 an average revisit time is adopted as the value subtracted from the revisit time, the relationship given is, for example, B2=Tₘₐₓ+Tₐᵥₑ×Tₜ/2Tₛ. Thereby, pulse pairs may be efficiently allocated to the target having the allocation number less than the prescribed value B1.

Meanwhile, at step S207, the allocator 103 substitutes the revisit time of the selected target with the original revisit time of this target.

At step S208, the allocator 103 determines whether the total allocation number has reached a prescribed value B3 or not. The total allocation number is a total sum of the pulse numbers allocated to the targets. The prescribed value B3 is a total sum of the maximum pulse numbers of the targets set by the feature quantity calculator 102. If the total allocation number is less than the prescribed value B3, the operation proceeds to step S201 to continue pulse pair allocation. If the total allocation number is equal to or greater than the prescribed value B3, the allocator 103 determines the pulse pair allocation to the targets and terminates the processing.

According to this embodiment, a target that easily lowers the correlation between pulse pairs may be preferentially allocated an appropriate number of pulses in pulse pair unit that accord with the weather situation of the target. That is, samples showing high independence between pulse pairs may be collected. As a result, estimation accuracy may be enhanced as compared to the case of continuous pulse allocation.

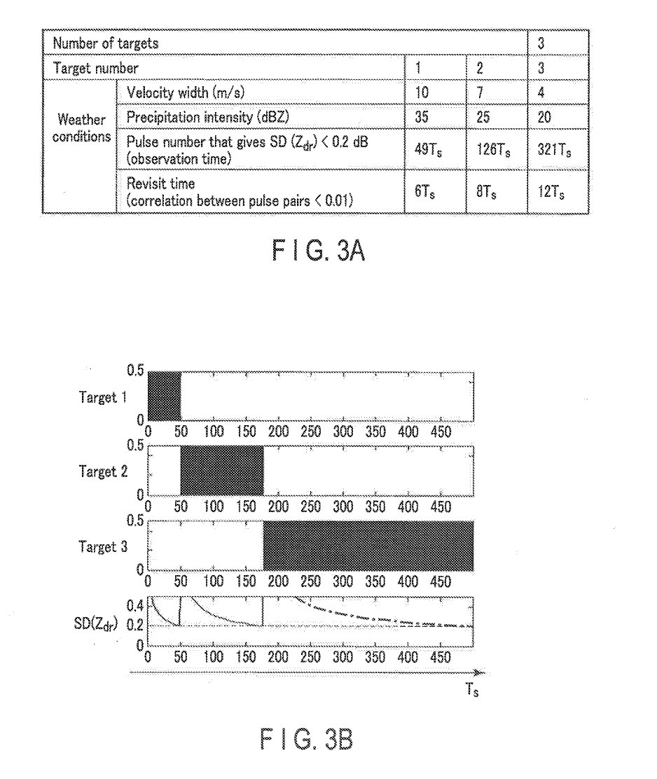

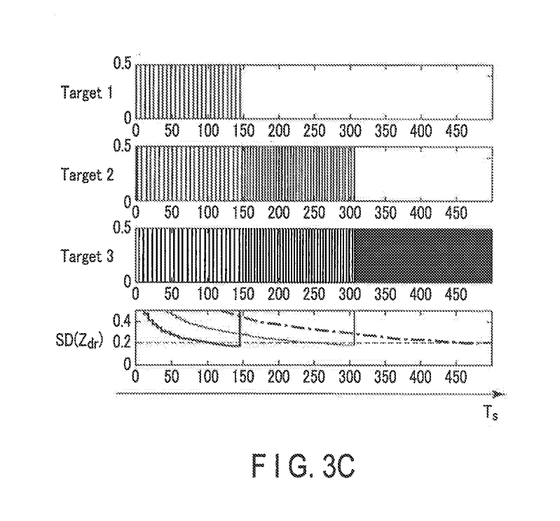

With reference to FIGS. 3A to 3C, descriptions will be made to the comparison in performance between the continuous pulse allocation according to a comparative example and the allocation according to the embodiment. FIG. 3A shows the weather conditions of each target when there are three targets in an environment. FIG. 3B shows a result of continuous pulse allocation under the weather conditions in FIG. 3A. FIG. 3C shows a result of allocation according to the embodiment under the weather conditions in FIG. 3A. Here, as one example, the number of pulses to be allocated to each target (prescribed value B1) is assumed to be the number of pulses that gives 0.2 dB as a standard deviation of a radar reflection factor difference Z_{dr}. FIGS. 3B and 3C each show the timings of pulse pairs allocated to targets 1 to 3, respectively from the top. Changes in standard deviation of the radar reflection factor difference Z_{dr} due to the pulse allocation are shown at the bottom. In the graph showing the changes in standard deviation of the radar reflection factor difference Z_{dr}, the bold solid line indicates the standard deviation of target 1, the thin solid line indicates the standard deviation of target 2, and the dashed-dotted line indicates the standard deviation of target 3. The broken line is drawn on the target value, 0.2 dB.

With the continuous pulse allocation as shown in FIG. 3B, continuous pulses are allocated to target 1, target 2 and target 3 in order. With the transmit allocation according to the embodiment as shown in FIG. 3C, the number of pulses that suits each weather situation is allocated in pulse pair unit. Specifically, pulse pairs are dynamically allocated such that a first pulse pair is allocated to target 1, a second pulse pair is allocated to target 2, a third pulse pair is allocated to target 3, a fourth pulse pair is allocated to target 1, a fifth pulse pair is allocated to target 2, and so on. Once the pulse number allocated to target 1 reaches 49 Tₛ, the transmit allocation to target 1 are halted. And once the pulse number allocated to target 2 reaches 126Tₛ, the transmit allocation to target 2 are halted. It may be confirmed from FIGS. 3B and 3C that when allocating the same number of pulses, the pulse allocation in pulse pair unit according to the embodiment allow the standard deviation as a data variation to be kept low as compared to the continuous pulse allocation.

As described above, the weather radar apparatus according to the first embodiment may realize fast and highly accurate observations by determining the transmit allocation to targets in pulse pair unit based on the feature quantities of the targets.

### Second Embodiment

Weather situations change from moment to moment. As such, data update is a requisite for grasping the changes in weather situations. Update times (data update frequency) vary depending on weather situations. In the second embodiment, descriptions will be made to a method of updating data at the update times that accord with the weather situation of each target.

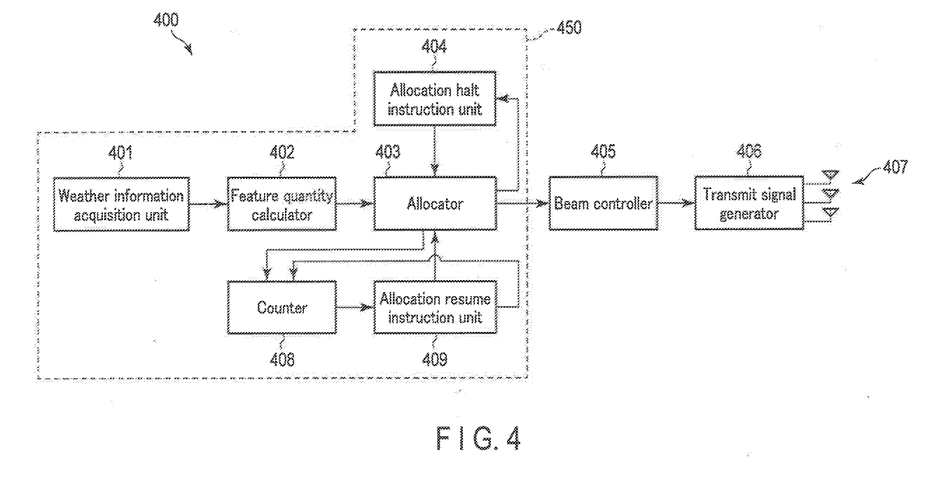

FIG. 4 schematically shows a weather radar apparatus 400 according to the second embodiment. The weather radar apparatus 400 includes an allocation controller 450, a beam controller 405, a transmit signal generator 406, and an array antenna 407. The allocation controller 450 includes a weather information acquisition unit 401, a feature quantity calculator 402, an allocator 403, an allocation halt instruction unit 404, a counter 408, and an allocation resume instruction unit 409. The weather information acquisition unit 401, feature quantity calculator 402, allocator 403, allocation halt instruction unit 404, beam controller 405, transmit signal generator 406 and array antenna 407 operate in the similar manner as described in the first embodiment in relation to the weather information acquisition unit 101, feature quantity calculator 102, allocator 103, allocation halt instruction unit 104, beam controller 105, transmit signal generator 106 and array antenna 107; thus, their descriptions will be omitted as appropriate.

The counter 408 counts a through observation time and a target's observation time. The through observation time indicates an observation time from the start of allocation.

The counter 408 starts counting at the same time as the start of allocation. Each time the allocator 403 allocates a pulse pair to any target, the counter 408 adds 2Tₛ to the through observation time and 2Tₛ to the observation times of all the targets. The allocation resume instruction unit 409 instructs the allocator 403 to resume transmit allocation to a target for which the observation time has reached a prescribed value. The prescribed value corresponds to the update time. The prescribed value may be determined from, for example, the wind velocity and observation resolution of each target. For example, when the wind velocity is 5 m/s and the observation resolution is 200 m, the prescribed value is determined to be 200/5=40 s. The prescribed value may vary target-by-target.

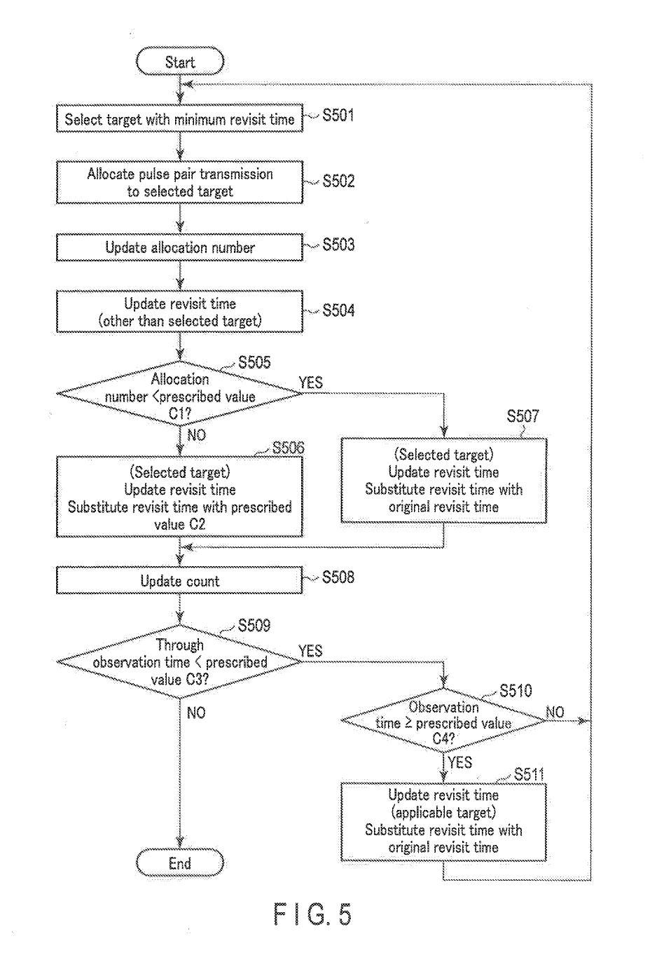

FIG. 5 shows an example of the transmit allocation method according to this embodiment. Steps S501 to S507 shown in FIG. 5 involve the same processing as steps S201 to S207 described with reference to FIG. 2; thus, their descriptions will be omitted as appropriate. FIG. 5 in step S505 mentions a prescribed value C1 which may be the same value as the prescribed value B1 mentioned in step S205 in FIG. 2 or may be a different value.

At step S502 in FIG. 5, the allocator 403 allocates a pulse pair to a target with the minimum revisit time. Thereafter at step S508, the counter 408 adds 2T₅ to the target's observation time as well as to the through observation time. Note that the initial value of each target's observation time and the initial value of the through observation time are zero.

At step S509, the through observation time is compared to a prescribed value C3. The prescribed value C3 may be, for example, a value equal to the total observation time in the target observation mode. If the through observation time is less than the prescribed value C3, the operation proceeds to step S510. If the through observation time is equal to or greater than the prescribed value C3, the transmit allocation are terminated.

At step S510, the allocation resume instruction unit 409 compares the observation time of each target to a prescribed value C4. If there are no targets of which observation time is equal to or greater than the prescribed value C4, the operation returns to step S501. If there are one or more targets of which observation time is equal to or greater than the prescribed value C4, the allocation resume instruction unit 409 instructs the allocator 403 to resume allocation to the target or targets of which observation time is equal to or greater than the prescribed value C4, and the counter 408 resets the observation time of such target or targets to zero. The operation then proceeds to step S511. At step S511, the allocator 403 substitutes the revisit time of the target or targets of which observation time is equal to or greater than the prescribed value C4 with the original revisit time of the target or targets. The operation then returns to step S501.

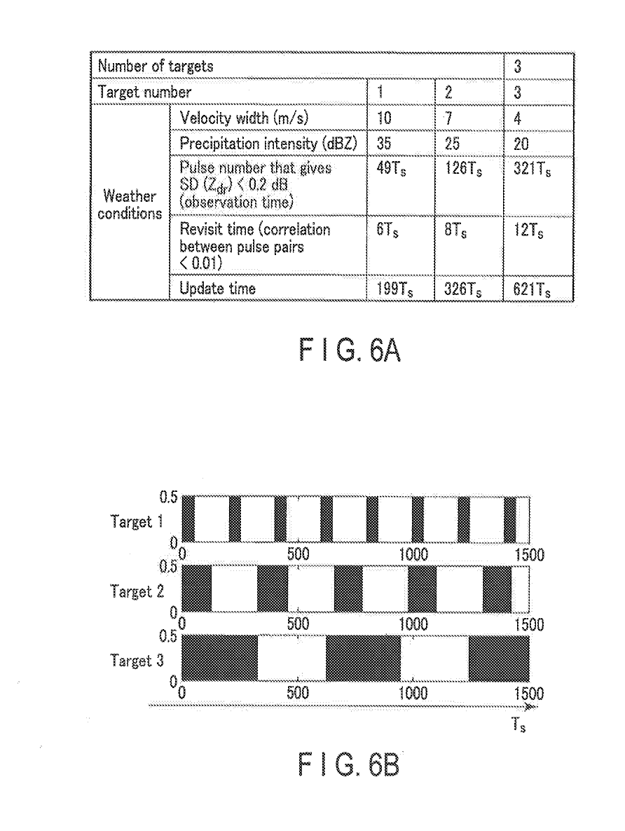

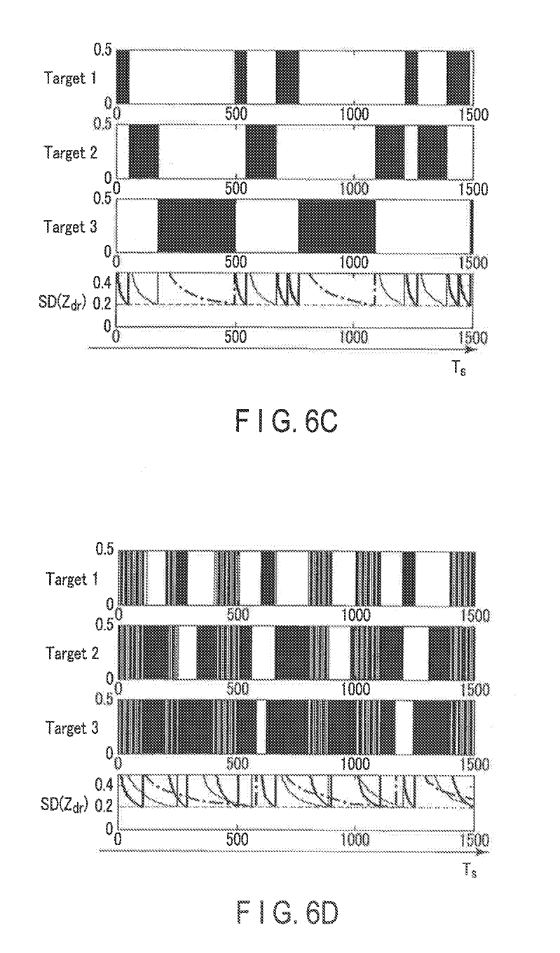

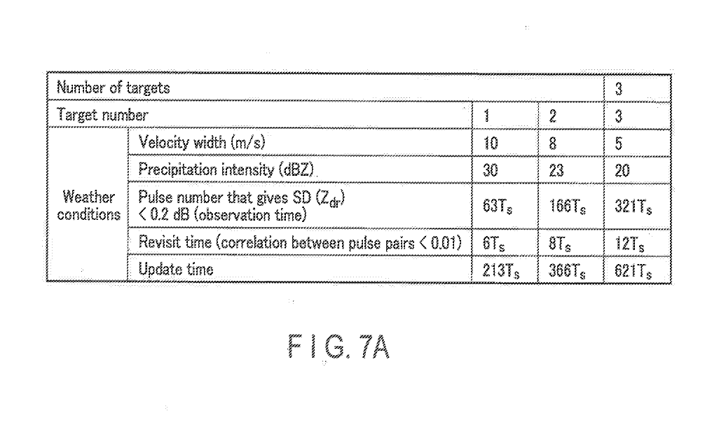

According to this embodiment, data may be updated at the update times that accord with the weather situation of each target. With reference to FIGS. 6A to 6D, descriptions will be made to the comparison in performance between the continuous pulse allocation according to a comparative example and the allocation according to the embodiment. FIG. 6A shows the weather conditions of each target when there are three targets in an environment. Here, as one example, the update time (prescribed value C4) is calculated as Tᵣ×25+Tₐ, where Tᵣ indicates the revisit time and Tₐ indicates the number of continuous pulses required to give 0.2 dB as a standard deviation of a radar reflection factor difference Z_{dr}.

FIG. 6B shows allocations of the three targets when continuous pulse allocation is performed in accordance with the update times shown in FIG. 6A without regard to the other targets. FIG. 6C shows a result of continuous pulse allocation under the weather conditions in FIG. 6A. FIG. 6D shows a result of allocation according to this embodiment under the weather conditions in FIG. 6A. From FIG. 6C where continuous pulses are allocated, it may be understood that during observation of a target having a large number of allocated pulses, the time that restricts continuous observation of the other targets increases, resulting in the delay of update times. From FIG. 6D, it may be confirmed that data may be acquired with a desired accuracy while the data is updated at appropriate update timings, without causing a delay in update times. It may also be confirmed that the number of data with an equivalent accuracy has increased to 1.23 times that of the continuous pulse allocation, exhibiting an effect of increasing the data amount acquirable during the same observation time.

As described above, the weather radar apparatus according to the second embodiment may realize the same effect as in the first embodiment and further enable observation at update times that accord with weather situations.

### Third Embodiment

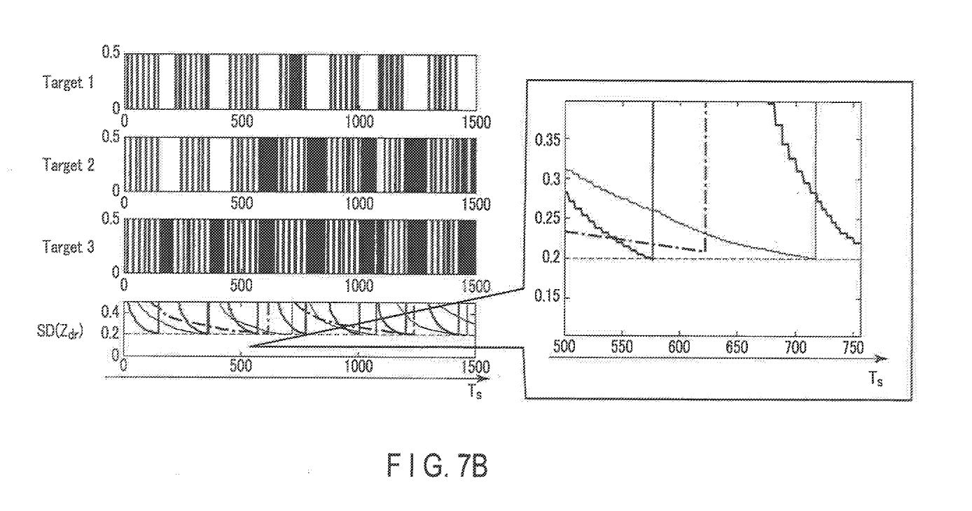

The second embodiment would forcibly update data upon getting to an update time. Due to this, if sufficiency of allocation is lacked, there would be a target that cannot be allocated pulses up to a desired observation accuracy. Such a situation will be shown in FIGS. 7A and 7B by way of example. FIG. 7A shows the weather conditions of each target when there are three targets in an environment.

FIG. 7B shows a result of allocation according to the second embodiment under the weather conditions in FIG. 7A.

FIG. 7B includes an enlarged view of the portion of the graph showing the changes in standard deviation of the radar reflection factor difference Z_{dr}. From FIG. 7B, it may be understood that the standard deviation of Z_{dr} of target 3 does not satisfy the target value, 0.2 dB. In the third embodiment, descriptions will be made to a method for avoiding occurrence of the target for which data is updated while the accuracy specification is yet to be satisfied.

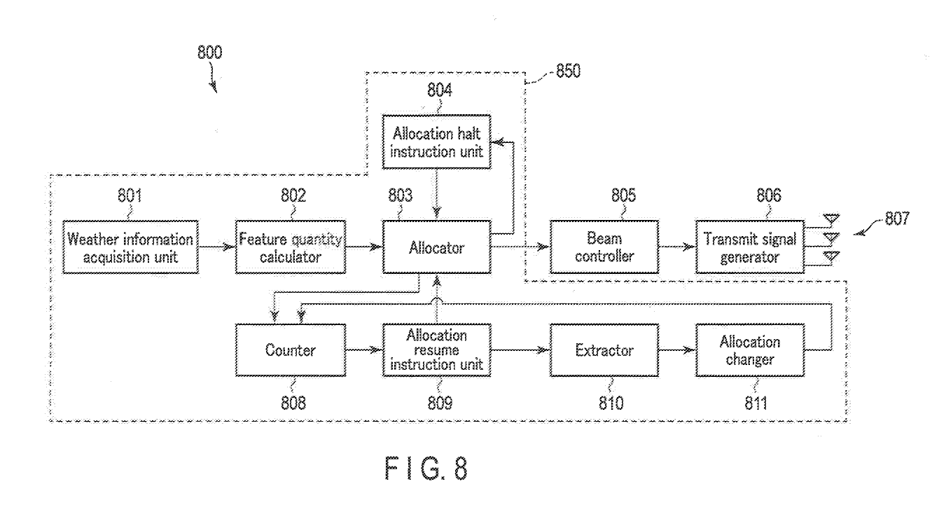

FIG. 8 schematically shows a weather radar apparatus 800 according to the third embodiment. The weather radar apparatus 800 includes an allocation controller 850, a beam controller 805, a transmit signal generator 806, and an array antenna 807. The allocation controller 850 includes a weather information acquisition unit 801, a feature quantity calculator 802, an allocator 803, an allocation halt instruction unit 804, a counter 808, an allocation resume instruction unit 809, an extractor 810, and an allocation changer 811. The weather information acquisition unit 801, feature quantity calculator 802, allocator 803, allocation halt instruction unit 804, beam controller 805, transmit signal generator 806 and array antenna 807 are for the similar operations as described in the first embodiment in relation to the weather information acquisition unit 101, feature quantity calculator 102, allocator 103, allocation halt instruction unit 104, beam controller 105, transmit signal generator 106 and array antenna 107, and the counter 808 and allocation resume instruction unit 809 are for the similar operations as described in the second embodiment in relation to the counter 408 and allocation resume instruction unit 409; thus, their descriptions will be omitted as appropriate.

If there is a target that does not satisfy the accuracy specification, i.e., a target for which observation accuracy resulted from the allocation does not meet a predetermined accuracy, the extractor 810 extracts a partial allocation of another target. For example, the extractor 810 extracts a partial allocation of the target having been allocated the most pulses. The allocation changer 811 changes transmit allocations such that the allocation extracted by the extractor 811 will be allocated to the target for which observation accuracy resulted from the allocation does not meet the predetermined accuracy.

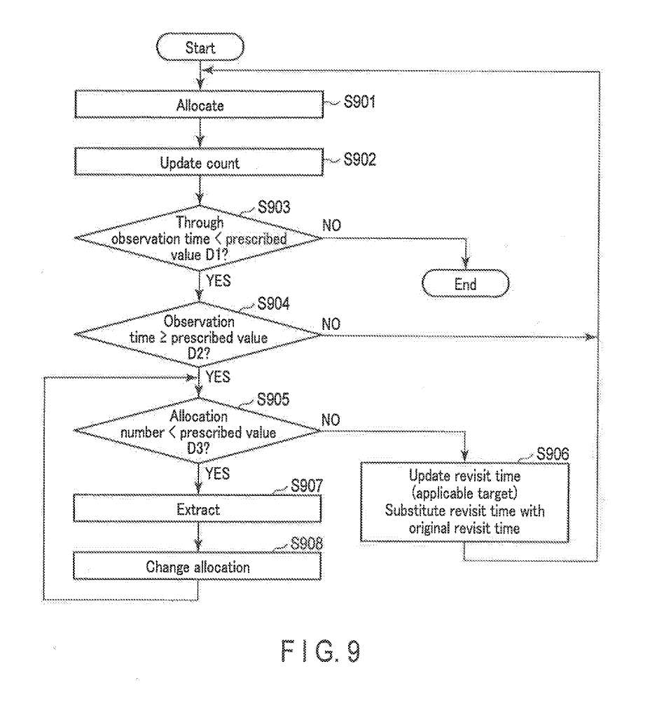

FIG. 9 shows an example of the transmit allocation method according to this embodiment. The processing of step S901 in FIG. 9 corresponds to the processing of steps S201 to S207 in FIG. 2 or the processing of steps S501 to S507 in FIG. 5. Upon start of transmit allocation, the counter 808 starts counting. When pulse pairs are allocated at step S901, the counter 808 adds 2T₅ to the target's observation time as well as to the through observation time at step S902.

At step S903, the through observation time is compared to a prescribed value D1. If the through observation time is less than the prescribed value D1, the operation proceeds to step S904. If the through observation time is equal to or greater than the prescribed value D1, the transmit allocation are terminated.

At step S904, the allocation resume instruction unit 809 compares the observation time of each target to a prescribed value D2. If there are no targets of which observation time is equal to or greater than the prescribed value D2, the operation returns to step S901. If there are one or more targets of which observation time is equal to or greater than the prescribed value D2, the allocation resume instruction unit 809 instructs the allocator 803 to resume allocation to the target or targets of which observation time is equal to or greater than the prescribed value D2, and the counter 808 resets the observation time of such target or targets to zero. The operation then proceeds to step 905. The prescribed value D2 may be the same value as the prescribed value C4 mentioned in step S510 in FIG. 5.

At step S905, the allocation number for the target of which observation time is equal to or greater than the prescribed value D2 is compared to a prescribed value D3. If the allocation number is equal to or greater than the prescribed value D3, the operation proceeds to step S906. Otherwise, the operation proceeds to step S907. Step S906 involves the same processing as step S511 in FIG. 5; thus, its descriptions will be omitted.

At step S907, the extractor 810 selects a target other than the target of which observation time has been determined to be equal to or greater than the prescribed value D2 at step S904 and of which allocation number has been determined to be less than the prescribed value D3 at step S905, and extracts a partial allocation of the selected target. At step S908, the extracted allocation is allocated to the target of which observation time has been determined to be equal to or greater than the prescribed value D2 at step S904 and of which allocation number has been determined to be less than the prescribed value D3 at step S905. The operation then returns to step S905.

As described above, according to the third embodiment, allocations (pulse pairs) may be given to a target having a small allocation number from a target having a large allocation number. As a result, the observation accuracy of each target may be increased to a desired value or greater.

The instructions indicated in the operation procedure of the above embodiments may be carried out based on a program as software. It is also possible that a general-purpose computer system stores such a program in advance and reads the program to produce the same effects as the weather radar apparatus described above. The instructions described in the above embodiments are stored in a magnetic disc (flexible disc, hard disc, etc.), an optical disc (CD-ROM, CD-R, CD-RW, DVD-ROM, DV±R, DVD±RW, Blu-ray disc, etc.), a semiconductor memory, or a similar storage medium, as a computer-executable program. As long as the storage medium is readable by a computer or embedded system, any storage type may be adopted. Upon reading the program from the storage medium and, based on the program, allowing a CPU to execute the instructions described in the program, a computer may realize the same operations as the weather radar apparatus of the above embodiments. Of course, the program may be acquired or read through a network when the computer is to acquire or read the program.

Also, an operating system (OS) that runs on a computer, database management software, middleware (MW) in a network, etc. may also execute part of each processing to realize the embodiments based on the instructions from the program installed from the storage medium to the computer or embedded system.

Further, the storage medium intended by the embodiments is not limited to a medium independent from a computer or embedded system, but may include a storage medium that downloads and stores or temporarily stores a program conveyed through LAN, the Internet, etc.

Still further, the number of storage medium is not limited to one but the embodiments may cover the instances where the processing according to the embodiments is performed with multiple storage media, and the storage media may take any configurations.

Additionally, the computer or embedded system in the embodiments may take any configurations such as an apparatus comprising a personal computer or a microcomputer, or a system comprising a plurality of apparatuses connected via a network, for use in executing each processing of the embodiments based on the program stored in the storage medium.

The computer in the embodiments is not limited to a personal computer but may include an arithmetic processing unit, a microcomputer, etc. contained in an information processing device, and the computer in the embodiments generally refers to a device and apparatus that may realize the functions intended by the embodiments using the program.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A weather radar apparatus comprising:
a weather information acquisition unit which acquires weather information for targets in an observation range;
a feature quantity calculator which calculates a feature quantity of each of the targets based on the weather information;
an allocator which performs transmit allocation in pulse unit or pulse pair unit to the targets based on the feature quantity;
an allocation halt instruction unit which instructs the allocator to halt transmit allocation to a target satisfying a certain condition;
a beam controller which generates a control signal to control a beam direction and transmit timing based on a result of the transmit allocation;
a transmit signal generator which generates a transmit signal based on the control signal; and
an array antenna which transmits the transmit signal.

2. The weather radar apparatus according to claim 1, wherein the feature quantity is a value based on a time such that pulses or pulse pairs have no correlation therebetween.

3. The weather radar apparatus according to claim 1, wherein the feature quantity is a time such that pulses or pulse pairs have no correlation therebetween.

4. The weather radar apparatus according to claim 1, wherein the certain condition is based on a comparison between a value based on a number of pulses allocated to each of the targets and a prescribed value based on accuracy for a weather parameter of each of the targets.

5. The weather radar apparatus according to claim 4, wherein the weather parameter is allowed to be different for each target.

6. The weather radar apparatus according to claim 1, wherein the certain condition is based on a comparison between a value based on a number of pulses allocated to each of the targets and a prescribed value set for each of the targets.

7. The weather radar apparatus according to claim 1, further comprising:
a counter which counts an observation time of each of the targets; and
an allocation resume instruction unit which instructs the allocator to resume transmit allocation to a target whose observation time is equal to or greater than a predetermined update time.

8. The weather radar apparatus according to claim 1, further comprising:
an extractor which, when there is a target not satisfying an accuracy specification, extracts a partial allocation of a target other than the target not satisfying the accuracy specification; and
an allocation changer which allocates the extracted allocation to the target not satisfying the accuracy specification.

9. A control apparatus for controlling an electronically beam-scannable weather radar apparatus comprising an array antenna, the control apparatus comprising:
a weather information acquisition unit which acquires weather information for targets in an observation range;
a feature quantity calculator which calculates a feature quantity of each of the targets based on the weather information;
an allocator which performs transmit allocation in pulse unit or pulse pair unit to the targets based on the feature quantity; and
an allocation halt instruction unit which instructs the allocator to halt transmit allocation to a target satisfying a certain condition.

10. A method of controlling an electronically beam-scannable weather radar apparatus comprising an array antenna, the method comprising:
acquiring weather information for targets in an observation range;
calculating a feature quantity of each of the targets based on the weather information;
performing transmit allocation in pulse unit or pulse pair unit to the targets based on the feature quantity; and
instructing to halt transmit allocation to a target satisfying a certain condition.

11. The method according to claim 10, wherein the feature quantity is a value based on a time such that pulses or pulse pairs have no correlation therebetween.

12. The method according to claim 10, wherein the feature quantity is a time such that pulses or pulse pairs have no correlation therebetween.

13. The method according to claim 10, wherein the certain condition is based on a comparison between a value based on a number of pulses allocated to each of the targets and a prescribed value based on accuracy for a weather parameter of each of the targets.

14. The method according to claim 13, wherein the weather parameter is allowed to be different for each target.

15. The method according to claim 10, wherein the certain condition is based on a comparison between a value based on a number of pulses allocated to each of the targets and a prescribed value set for each of the targets.

16. The method according to claim 10, further comprising:
counting an observation time of each of the targets; and
instructing the allocator to resume transmit allocation to a target whose observation time is equal to or greater than a predetermined update time.

17. The method according to claim 10, further comprising:
when there is a target not satisfying an accuracy specification, extracting a partial allocation of a target other than the target not satisfying the accuracy specification; and
allocating the extracted allocation to the target not satisfying the accuracy specification.
